(19) United States
(12) Patent Application Publication
(10) Pub. No.: US 2015/0074519 A1
(43) Pub. Date: Mar. 12, 2015

(54) METHOD AND APPARATUS OF CONTROLLING PAGE ELEMENT

(71) Applicant: Alibaba Group Holding Limited, Grand Cayman (KY)

(72) Inventor: Peng He, Hangzhou (CN)

(21) Appl. No.: 14/480,360

(22) Filed: Sep. 8, 2014

(30) Foreign Application Priority Data
Sep. 9, 2013 (CN) 201310406716.7

(51) Int. Cl. G06F 17/21; G06F 17/22

(52) U.S. Cl. CPC G06F 17/211; G06F 17/2247
USPC 715/235

(57) ABSTRACT

The present disclosure provides a method and an apparatus of controlling a page element. The embodiments of the present disclosure create an auxiliary page element according to a Web page (a size of the auxiliary page element being a size of the Web page), and obtain a size of a frame of the auxiliary page element based on the size of the auxiliary page element and the size and a position of the target page element, thus allowing to configure a manner of displaying the frame of the auxiliary page element to be different from a manner of displaying the target page element. Since the target page element is not separated from a document flow of the Web page at all times, the problem of reconfiguring a style of a replicated page element caused by separation of the replicated page element (i.e., the target page element) from the document flow of the Web page in existing technologies is thus avoided. The operations are simple with high accuracy, thereby improving the efficiency and the reliability of page element control.

CROSS REFERENCE TO RELATED PATENT APPLICATION

This application claims foreign priority to Chinese Patent Application No. 201310406716.7 filed on Sep. 9, 2013, entitled “Method and Apparatus of Controlling Page Element”, which is hereby incorporated by reference in its entirety.

### TECHNICAL FIELD

The present disclosure is related to World Wide Web (or abbreviated as Web) page processing technologies, and more particularly to methods and apparatuses of controlling a page element.

### BACKGROUND

With the development of communication technologies, more functions are integrated into a terminal device, leading to an increasing number of corresponding application programs to be included in a system function list of the terminal device, e.g., an application program installed in a computer, or a third-party application (i.e., APP) installed in a smartphone. Some application programs may involve World Wide Web (i.e., Web) pages. A Web page may include a display block (which is called a page element) formed by one or more HTML (Hyper Text Markup Language) tags, such as a text, a tag, a hyperlink, a button, an input box and a pull-down list, etc. Under some circumstances, a designated page element is needed to be prominently displayed. For instance, a page element that has been changed is needed to be prominently displayed after a layout of a Web page is modified. In existing technologies, a translucent layer is configured on the Web page, a page element that needs to be prominently displayed is replicated, and the replicated page element is placed on top of the translucent layer so as to achieve the objective of prominent display of the replicated paged element. However, since the replicated page element is individually placed on top of the translucent layer of the Web page, the replicated page element is separated from a document flow of the Web page. Accordingly, reconfiguration is needed for the replicated page element in order to maintain original display effects. A document flow of a Web page refers to a position occupied by a displayable object, i.e., a page element, on the Web page during arrangement.

However, since the replicated page element has separated from the document flow of the Web page, a style for the page element cannot be configured according to the document flow, but the style of the page element can only be separately determined with complicated operations which are prone to errors, thus resulting in lowering of the efficiency and the reliability of page element control.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Various aspects of the present disclosure provide a method and an apparatus of controlling a page element in order to improve the efficiency and the reliability of page element control.

According to an aspect of the present disclosure, a method of controlling a page element is provided, which includes:

determining a target page element to be controlled on a Web (World Wide Web) page;

creating an auxiliary page element according to the Web page, a size of the auxiliary page element being a size of the Web page;

obtaining a size of a frame of the auxiliary page element based on the size of the auxiliary page element and a size and a position of the target page element; and

configuring a manner of displaying the frame of the auxiliary page element to be different from a manner of displaying the target page element.

According to the above aspect and any possible implementation, an implementation is further provided for configuring the manner of displaying the frame of the auxiliary page element to be different from the manner of displaying the target page element, which includes:

based on a predetermined transparency parameter, setting a transparency degree for the frame of the auxiliary page element, the transparency parameter being greater than or equal to zero and is less than one.

According to the above aspect and any possible implementation, an implementation is further provided for obtaining the size of the frame of the auxiliary page element based on the size of the auxiliary page element and the size and the position of the target page element, which includes:

obtaining a size difference between the auxiliary page element and the target page element in each direction based on the size of the auxiliary page element and the size and the position of the target page element; and

obtaining the size of the frame of the auxiliary page element based on the size difference in each direction.

According to the above aspect and any possible implementation, an implementation is further provided for creating the auxiliary page element, which include:

creating the auxiliary page element under a body tag of the Web page.

According to the above aspect and any possible implementation, an implementation is further provided. Prior to obtaining the size of the frame of the auxiliary page element based on the size of the auxiliary page element and the size and the position of the target page element, the method further includes:

determining the size and the position of the target page element using JavaScript language.

According to the above aspect and any possible implementation, an implementation is further provided. The auxiliary page element is a block element.

According to the above aspect and any possible implementation, an implementation is further provided. A height of the auxiliary page element is greater than a height of any page element other than the target page element on the Web page.

According to another aspect of the present disclosure, an apparatus of controlling a page element is provided, which includes:

a determination unit used for determining a target page element to be controlled on a Web page of World Wide Web;

a creation unit used for creating an auxiliary page element according to the Web page, a size of the auxiliary page element being a size of the Web page;

an acquisition unit used for obtaining a size of a frame of the auxiliary page element based on the size of the auxiliary page element and a size and a position of the target page element; and

a configuration unit used for configuring a manner of displaying the frame of the auxiliary page element to be different from a manner of displaying the target page element.

According to the above aspect and any possible implementation, an implementation is further provided. The configuration unit is used for setting up a transparency degree for the frame of the auxiliary page element based on a preset transparency parameter, the transparency parameter being greater than or equal to zero and is less than one.

According to the above aspect and any possible implementation, an implementation is further provided. The acquisition unit is used for

obtaining a size difference between the auxiliary page element and the target page element in each direction based on the size of the auxiliary page element and the size and the position of the target page element; and

obtaining the size of the frame of the auxiliary page element based on the size difference in each direction.

According to the above aspect and any possible implementation, an implementation is further provided. The creation unit is used for creating the auxiliary page element under a body tag of the Web page.

According to the above aspect and any possible implementation, an implementation is further provided. The determination unit is further used for determining the size and the position of the target page element using JavaScript language.

According to the above aspect and any possible implementation, an implementation is further provided. The auxiliary page element is a block element.

According to the above aspect and any possible implementation, an implementation is further provided. A height of the auxiliary page element is greater than a height of any page element other than the target page element on the Web page.

As can be seen from the above technical scheme, the embodiments of the present disclosure create an auxiliary page element according to a Web page (a size of the auxiliary page element being a size of the Web page), and obtain a size of a frame of the auxiliary page element based on the size of the auxiliary page element and the size and a position of the target page element, thus allowing to configure a manner of displaying the frame of the auxiliary page element to be different from a manner of displaying the target page element. Since the target page element is not separated from a document flow of the Web page at all times, the problem of reconfiguring a style of a replicated page element caused by separation of the replicated page element (i.e., the target page element) from the document flow of the Web page in existing technologies is thus avoided. The operations are simple with high accuracy, thereby improving the efficiency and the reliability of page element control.

### BRIEF DESCRIPTION OF THE DRAWINGS

In order to clearly describe the technical scheme in the embodiments of the present disclosure, drawings used for explaining the embodiments or the existing technologies are briefly introduced. The embodiments described hereinafter are only some embodiments of the present disclosure. Other embodiments can be obtained by a person with an ordinary skill in the art based on these drawings without paying any creative effort.

FIG. 1 is a flowchart illustrating a method of controlling a page element in accordance with an embodiment of the present disclosure.

FIG. 2 is a schematic diagram illustrating a Web page 200 corresponding to the embodiment shown in FIG. 1.

FIG. 3 is a schematic diagram illustrating another Web page 300 corresponding to the embodiment shown in FIG. 1.

FIG. 4 is a schematic diagram illustrating another Web page 400 corresponding to the embodiment shown in FIG. 1.

FIG. 5 is a structural diagram illustrating a control apparatus of page elements according to another embodiment of the present disclosure.

FIG. 6 is a structural diagram illustrating the apparatus described in FIG. 5 in further details.

### DETAILED DESCRIPTION

The technical schemes in the embodiments of the present disclosure will be described clearly and comprehensively in conjunction with the accompanied drawings to facilitate a better understanding of the objectives, technical schemes and advantages of the embodiments of the present disclosure. The embodiments described herein are only a part but not all of the embodiments of present disclosure. Based on the embodiments in the present disclosure, all other embodiments obtained by a person of ordinary skill in the art without a creative effort should be included in the scope of the present disclosure.

It is noted that a terminal device involved in the embodiments of the present disclosure may include, but is not limited to, a mobile phone, a personal digital assistant (PDA), a wireless hand-held device, a wireless notebook, a personal computer, a portable computer, a PC (personal computer), a MP3 player, a MP4 player, etc.

Moreover, a term “and/or” in the disclosure merely describes a relationship between related objects, representing three types of possible relationship. For example, A and/or B may represent: three types of situations, an existence of A only, an existence of both A and B, and an existence of B only. Furthermore, a character “/” used in the present disclosure generally represents a “or” relationship between objects at two sides thereof.

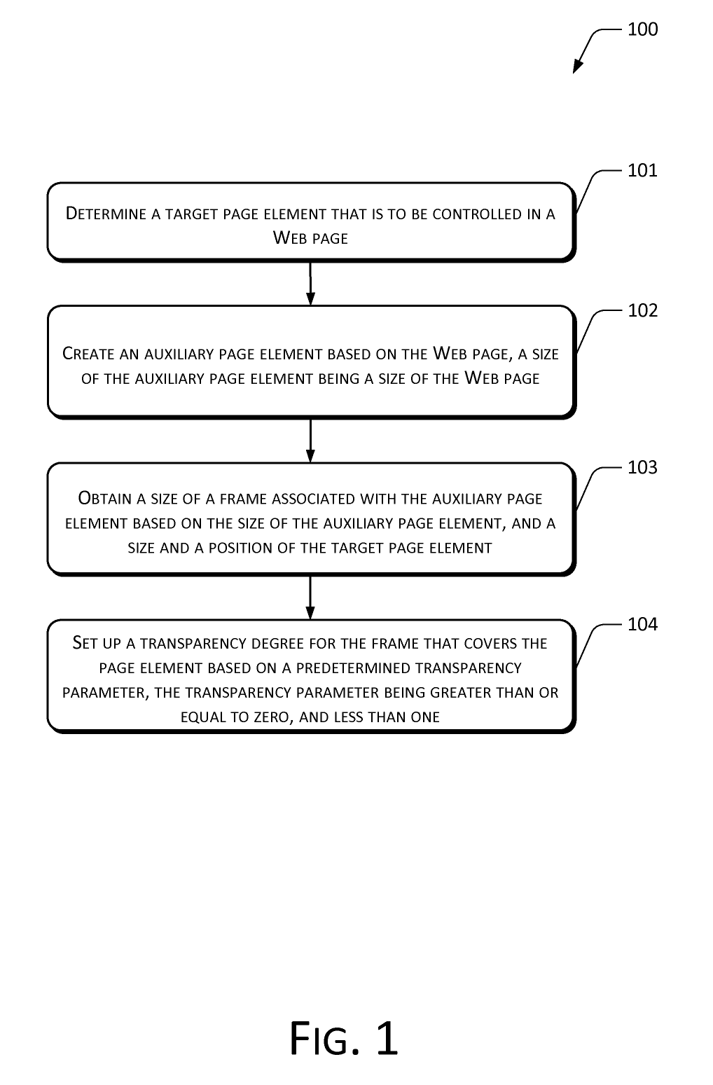

FIG. 1 is a flowchart illustrating a method 100 of controlling a page element in accordance with the first embodiment of the present disclosure.

Block 101 determines a target page element that is to be controlled in a Web page.

Specifically, the target page element may include, but is not limited to, at least one of the following items: a text, a tag, a hyperlink, a button, an input box and a pull-down list. The present embodiment has no limitation thereon. The target page element corresponds to a page element that needs to be prominently displayed.

Block 102 creates an auxiliary page element based on the Web page, a size of the auxiliary page element being a size of the Web page.

By executing block 102, an auxiliary page element having a size of the Web page is created in the Web page. The auxiliary page element corresponds to any page element of the Web page other than the target page element. For example, the auxiliary page element can be placed on top of any page element of the Web page other than the target page element or overlap with any page element of the Web other than the target page element.

In an embodiment, a vertical height of the auxiliary page element is greater than a vertical height of any page element of the Web page other than the target page element, so that the auxiliary page element, when set as an opaque status, can fully obscure the page element of the Web page other than the target page element.

It is noted that the vertical height of an auxiliary page element is unrelated to the vertical height of the target page element, i.e., the vertical height of the auxiliary page element can be greater than, equal to or less than the vertical height of the target page element. The present embodiment has no limitation thereto.

Block 103 obtains a size of a frame associated with the auxiliary page element based on the size of the auxiliary page element, and a size and a position of the target page element.

Specifically, the frame of the auxiliary page element may correspond to a portion located between an outer edge of the auxiliary page element and an outer edge of the target page element. Based on the size of the auxiliary page element and the size and the position of the target page element, a size difference between the auxiliary page element and the target page element in each direction can be obtained. Based on the size difference in each direction, the size of the frame of the auxiliary page element, i.e. a width of an upper border, a width of a lower border, a width of a left border and a width of a right border, can be obtained.

Thus, an allocation of the frame of the auxiliary page element on any page element of the Web page other than the target page element can be implemented.

Block 104 sets up a transparency degree for the frame that covers the page element based on a predetermined transparency parameter, the transparency parameter being greater than or equal to zero, and less than one.

In this way, since only the transparency degree is set such as the frame of the auxiliary page element is set in a partially-transparent state and other portions of the auxiliary page element is set as being completely transparent by default (i.e., the parameter of the transparency degree is one), the target page element can be prominently displayed.

It is noted that block 104 is merely a preferred embodiment of the present disclosure. In a practical implementation, in order to have the target page element to be prominently displayed, a style of displaying the frame of the auxiliary page element can be set to be different from a style of displaying the target page element. For example, if a main color of the target page element is red, the frame of the auxiliary page element can be set in light green color. Any other implementations that can achieve the objective of the present disclosure are included in the scope of present disclosure. The present disclosure does not impose any limitation thereto.

It is noted that the page involved in the present disclosure may be a Web page coded using HTML (Hyper Text Markup Language), or called as a Web page.

It is noted that an entity performing blocks 101 to 104 can be a control apparatus, such as a Web pages editor, etc., which may be located in a local client for offline control, or may be located in a server on a network side for online control. The present embodiment does not impose any limitation thereon.

It is noted that the client may be an application program installed in a terminal or a Web page of a browser. As long as a page element control can be achieved, a prominent display of the page element in an objective manner is also acceptable. The present embodiment does not impose any limitation thereon.

Using the technical scheme of the present disclosure, no operation is performed for the target page element so that the target page element does not have any change in position, and thus does not separate from a document flow of the Web page.

In this way, since no operation is performed for the target page element, and thus no change in the position of the target page element occurs (i.e., the target page element does not separate from the document flow of the Web page at all times), the problem of reconfiguring a style of a replicated page element caused by separation of the replicated page element (i.e., the target page element) from the document flow of the Web page in existing technologies is thus avoided. The operations are simple with high accuracy, thereby improving the efficiency and the reliability of page element control.

Moreover, by using the technical scheme provided in the present disclosure, as the target page element does not separate from document flow of the Web page at all times, an original style of the target page element is still effective without the need of re-configuring a style of a replicated page element, thus reducing a great number of operations for configuring the style and thereby improving the efficiency of the page element control.

Moreover, by using the technical scheme provided by the present disclosure and using a frame of a page element (i.e., an auxiliary page element) to process a translucent layer or an opaque layer, the objective of prominently displaying a page element (i.e., a target page element) without the need of changing an original document flow of a Web page is achieved.

The existing method of controlling a page element first sets up a translucent layer on top of a whole web page, replicates a page element that is to be displayed prominently, and places the replicated page element on top of the translucent layer so as to achieve the purpose of prominently displaying the replicated page element. As the replicated page element is individually placed on the translucent layer of the Web page, the replicated page element is made to separate from the document flow of the Web page. Therefore, the replicated page element needs to be configured again in order to maintain an original display effect. As such, since the replicated page element has separated from the document flow of the Web page, a style for the page element cannot be configured according to the document flow, but the style of the page element can only be separately determined with complicated operations which are prone to errors, thus resulting in lowering of the efficiency and the reliability of page element control.

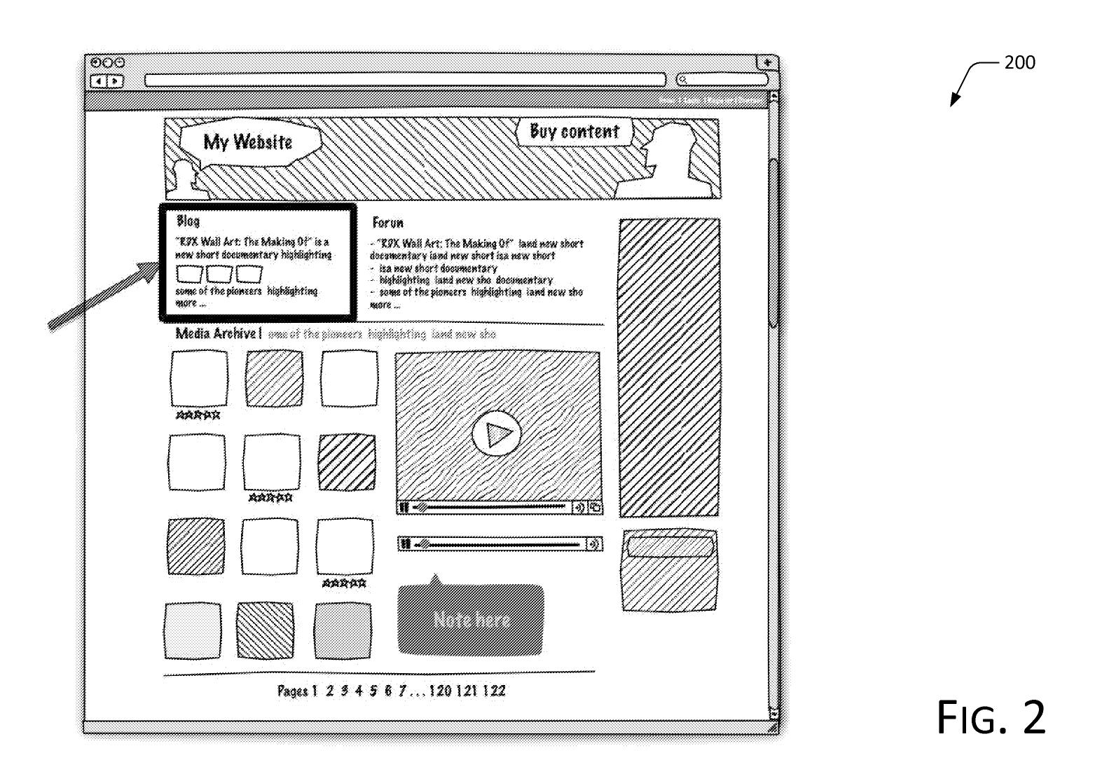

Optionally, in a plausible implementation of the present embodiment, prior to block 103, the control apparatus may further determine the size and the position of the target page element using the JavaScript language. As shown in FIG. 2, the one that is referred to by a directed arrow in the figure is the target page element.

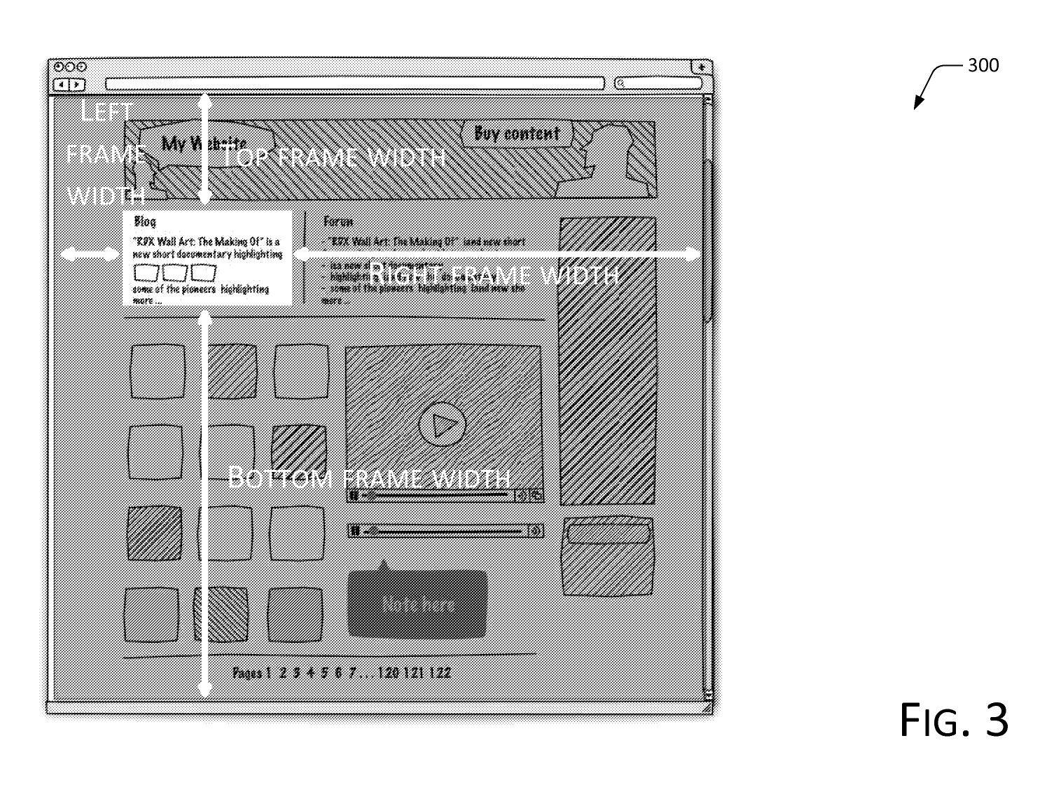

Specifically, at block 103, the control apparatus can obtain, based on the size of the auxiliary page element and the size and the position of the target page element, a size difference between the auxiliary page element and the target page element in every direction, including a size difference in an upper end, a size difference in a lower end, a size difference in a left end and a size difference in a right end. The control apparatus may then obtain, based on the size difference in each direction, the frame size of the auxiliary page element, i.e., a width of an upper frame, a width of a lower frame, a width of a left frame and a width of a right frame. As shown in FIG. 3, the frame size of the auxiliary page element corresponds to the areas where the bidirectional arrows are pointed.

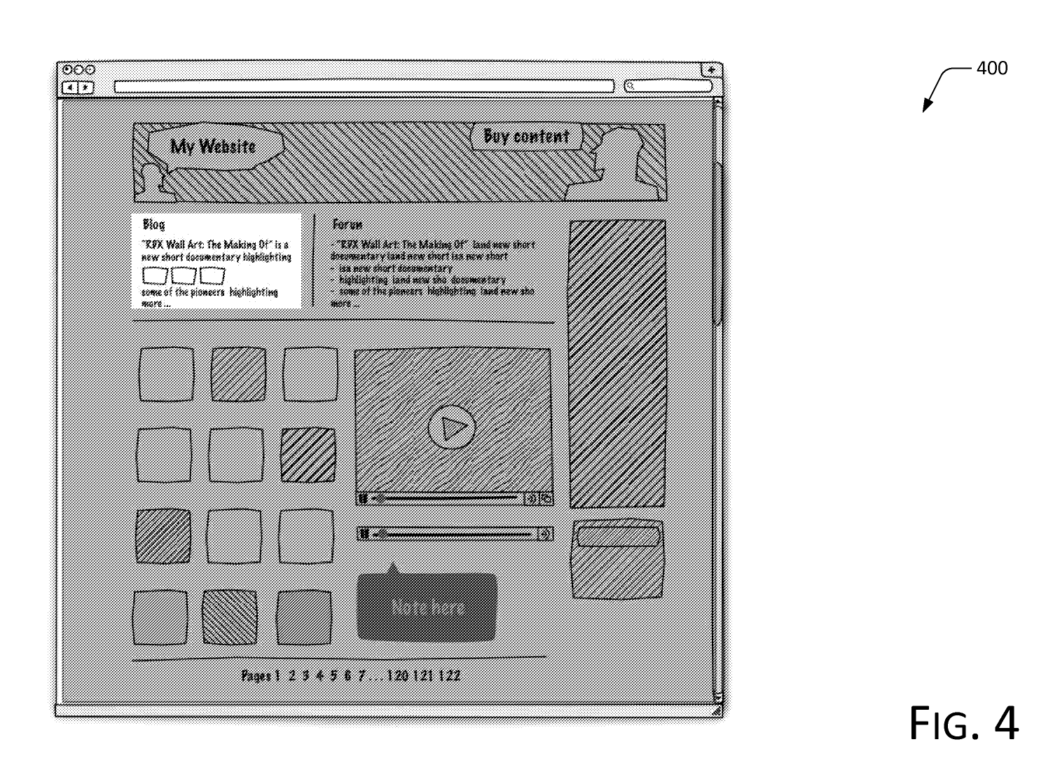

Accordingly, FIG. 4 shows a Web page obtained after the control apparatus performs block 104.

It is noted that, in the Web pages shown in FIGS. 2-4, only a layout of the Web page (i.e., size(s) and position(s) of page element(s)) is needed to be concerned, without the need of considering content of the page element(s). In other words, English characters included in the content of the page element(s) are merely indicative without any particular meaning, and thus can be ignored.

Optionally, in a plausible implementation of the present embodiment, at block 102, the control apparatus can create the auxiliary page element within a body tag of the Web page. Specifically, the auxiliary page element is a block element, where a scheme of absolute positioning may be used for the auxiliary page element which coordinate can be (0, 0), for example. Alternatively, a scheme of relative positioning can be applied, with coordinate to be (0, 0), for example. The present embodiment does not impose any limitation thereon.

The present embodiment creates, based on a Web page, an auxiliary page element having a size of the Web page, and obtains, based on the size of the auxiliary page element and a size and a position of a target page element, a size of a frame associated with the auxiliary page element in order to allow configuration of the frame of the auxiliary page element to be displayed with a style different from a style of displaying the target page element. Since no operation has been performed on the target page element, the position of the target page element does not change, i.e., the target page element does not separate from a document flow of the Web page at any time. Therefore the problem of reconfiguring a style of a replicated page element caused by separation of the replicated page element (i.e., the target page element) from the document flow of the Web page in existing technologies is thus avoided. The operations are simple with high accuracy, thereby improving the efficiency and the reliability of page element control.

Moreover, by using the technical scheme provided in the present disclosure, as the target page element does not separate from document flow of the Web page all times, an original style of the target page element is still effective without the need of re-configuring a style of a replicated page element, thus reducing a great number of operations for configuring the style and thereby improving the efficiency of the page element control.

Moreover, by using the technical scheme provided by the present disclosure and using a frame of a page element (i.e., an auxiliary page element) to process a translucent layer or an opaque layer, the objective of prominently displaying a page element (i.e., a target page element) without the need of changing an original document flow of a Web page is achieved.

It is noted that, for the sake of description, the foregoing method embodiments are expressed as a sequence of actions. However, one of ordinary skill in the art should understand that the present disclosure is not limited to the aforementioned order of actions. It is because certain blocks may be performed in a different order or in parallel according to the present disclosure. Furthermore, one of ordinary skill in the art should also understand that the embodiments as described herein are preferred embodiments. The operations and modules involved therein may not be essential in the disclosed methods.

In the foregoing embodiments, the description of each embodiment has a different emphasis. A portion that is missing in a certain embodiment can be found in a related description of other embodiments.

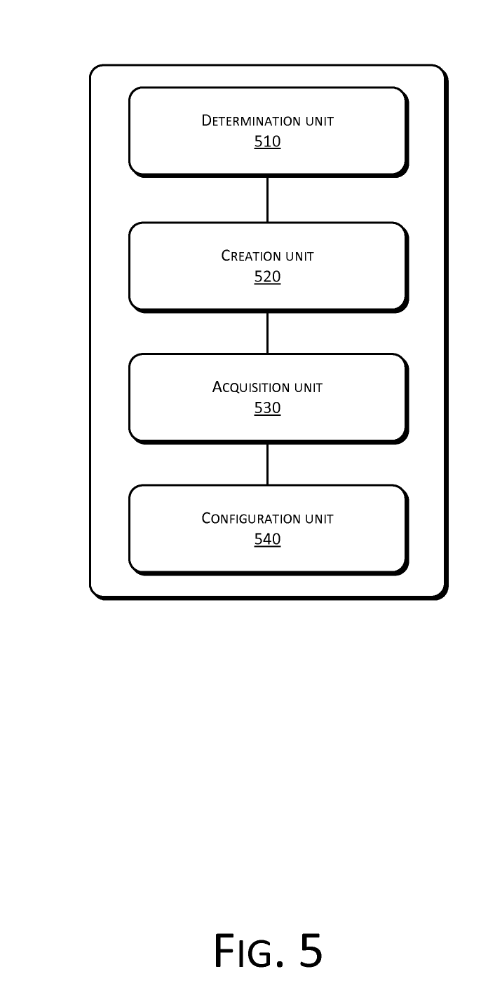

FIG. 5 is a structural diagram illustrating a control apparatus of page element in accordance with another embodiment of the present disclosure. As shown in FIG. 5, the example control apparatus of page element includes a determination unit 510, a creation unit 520, an acquisition unit 530 and a configuration unit 540. The determination unit 510 is used for determining a target page element to be controlled on a Web page of World Wide Web. The creation unit 520 is used for creating an auxiliary page element according to the Web page, a size of the auxiliary page element being a size of the Web page. The acquisition unit 530 is used for obtaining a size of a frame of the auxiliary page element based on the size of the auxiliary page element and a size and a position of the target page element. The configuration unit 540 is used for configuring a manner of displaying the frame of the auxiliary page element to be different from a manner of displaying the target page element.

Specifically, the target page element may include, but is not limited to, at least one of the following items: a text, a tag, a hyperlink, a button, an input box and a pull-down list. The present embodiment has no limitation thereon. The target page element corresponds to a page element that needs to be prominently displayed.

By performing corresponding operations, the creation unit 520 creates, on a Web page, an auxiliary page element having a size of the Web page, with the auxiliary page element corresponding to all page elements of the Web page other than the target page element. For example, the auxiliary page element can be placed on top of any page element of the Web page other than the target page element or overlap with any page element of the Web other than the target page element.

In an embodiment, a vertical height of the auxiliary page element is greater than a vertical height of any page element of the Web page other than the target page element, so that the auxiliary page element, when set as an opaque status, can fully obscure the page element of the Web page other than the target page element.

It is noted that the vertical height of auxiliary page element is unrelated to the vertical height of the target page element, i.e., the vertical height of the auxiliary page element can be greater than, equal to or less than the vertical height of the target page element. The present embodiment has no limitation thereto.

It is noted that the page involved in the present disclosure may be a Web page coded using HTML (Hyper Text Markup Language), or called as a Web page.

Specifically, the frame of the auxiliary page element may corresponds to a portion located between an outer edge of the auxiliary page element and an outer edge of the target page element. The acquisition unit 530 obtains a size difference between the auxiliary page element and the target page element in each direction based on the size of the auxiliary page element and the size and the position of the target page element. The acquisition unit obtains the size of the frame of the auxiliary page element based on the size difference in each direction, i.e. a width of an upper border, a width of a lower border, a width of a left border and a width of a right border.

As such, the frame that implements the auxiliary page element is placed on top of page elements other than the target page element of the Web page.

Optionally, in a plausible implementation of the present embodiment, the configuration unit 540 may set up a transparency degree for the frame that covers the page element based on a predetermined transparency parameter, the transparency parameter being greater than or equal to zero, and less than one. Since the configuration unit 540 only sets up the transparency degree for the frame of the auxiliary page element in a state of not completely transparency, and transparency of other portions of the auxiliary page element is set as being completely transparent by default, i.e. the parameter of the transparency degree is one, the target page element can be prominently displayed.

It is noted that if a main color of the target page element is red, the configuration unit 540 may set the frame of the auxiliary page element in light green color. Any other implementations that can achieve the objective of the present disclosure are included in the scope of present disclosure. The present disclosure does not impose any limitation thereto.

It is noted that the apparatus provided in this embodiment can be a control apparatus, such as a Web pages editor, etc., which may be located in a local client for offline control, or may be located in a server on a network side for online control. The present embodiment does not impose any limitation thereon.

It is noted that the client may be an application program installed in a terminal or a Web page of a browser. As long as a page element control can be achieved, a prominent display of the page element in an objective manner is also acceptable. The present embodiment does not impose any limitation thereon.

Using the technical scheme of the present disclosure, no operation is performed for the target page element so that the target page element does not have any change in position, and thus does not separate from a document flow of the Web page.

In this way, since no operation is performed for the target page element, and thus no change in the position of the target page element occur (i.e., the target page element does not separate from the document flow of the Web page at all times), the problem of reconfiguring a style of a replicated page element caused by separation of the replicated page element (i.e., the target page element) from the document flow of the Web page in existing technologies is thus avoided. The operations are simple with high accuracy, thereby improving the efficiency and the reliability of page element control.

Moreover, by using the technical scheme provided in the present disclosure, as the target page element does not separate from document flow of the Web page all times, an original style of the target page element is still effective without the need of re-configuring a style of a replicated page element, thus reducing a great number of operations for configuring the style and thereby improving the efficiency of the page element control.

Moreover, by using the technical scheme provided by the present disclosure and using a frame of a page element (i.e., an auxiliary page element) to process a translucent layer or an opaque layer, the objective of prominently displaying a page element (i.e., a target page element) without the need of changing an original document flow of a Web page is achieved.

The existing method of controlling a page element first sets up a translucent layer on top of a whole web page, replicates a page element that is to be displayed prominently, and places the replicated page element on top of the translucent layer so as to achieve the purpose of prominently displaying the replicated page element. As the replicated page element is individually placed on the translucent layer of the Web page, the replicated page element is made to separate from the document flow of the Web page. Therefore, the replicated page element needs to be configured again in order to maintain an original display effect. As such, since the replicated page element has separated from the document flow of the Web page, a style for the page element cannot be configured according to the document flow, but the style of the page element can only be separately determined with complicated operations which are prone to errors, thus resulting in lowering of the efficiency and the reliability of page element control.

Optionally, in a plausible implementation of the present embodiment, the determination unit 510 may further determine the size and the position of the target page element using the JavaScript language. As shown in FIG. 2, the one that is referred to by a directed arrow in the figure is the target page element.

Specifically, the acquisition unit 530 may obtain, based on the size of the auxiliary page element and the size and the position of the target page element, a size difference between the auxiliary page element and the target page element in every direction, including a size difference in an upper end, a size difference in a lower end, a size difference in a left end and a size difference in a right end. The control apparatus may then obtain, based on the size difference in each direction, the frame size of the auxiliary page element, i.e., a width of an upper frame, a width of a lower frame, a width of a left frame and a width of a right frame. As shown in FIG. 3, the frame size of the auxiliary page element corresponds to the areas where the bidirectional arrows are pointed.

FIG. 4 shows a Web page that is obtained after the configuration unit 54 performs the operations for setting up the transparency degree of the frame that covers the page element(s) based on the predetermined transparency parameter, where the transparency parameter is greater than or equal to zero and is less than one.

It is noted that, in the Web pages shown in FIGS. 2-4, only a layout of the Web page (i.e., size(s) and position(s) of page element(s)) is needed to be concerned, without the need of considering content of the page element(s). In other words, English characters included in the content of the page element(s) are merely indicative without any particular meaning, and thus can be ignored.

Optionally, in a plausible implementation of the present embodiment, the creation unit 520 can create the auxiliary page element within a body tag of the Web page. Specifically, the auxiliary page element is a block element, where a scheme of absolute positioning may be used for the auxiliary page element which coordinate can be (0, 0), for example. Alternatively, a scheme of relative positioning can be applied, with coordinate to be (0, 0), for example. The present embodiment does not impose any limitation thereon.

In the present embodiment, the creation unit 520 creates, based on a Web page, an auxiliary page element having a size of the Web page. The acquisition unit obtains, based on the size of the auxiliary page element and a size and a position of a target page element, a size of a frame associated with the auxiliary page element in order to allow the configuration unit to configure the frame of the auxiliary page element to be displayed with a style different from a style of displaying the target page element. Since no operation has been performed on the target page element, the position of the target page element does not change, i.e., the target page element does not separate from a document flow of the Web page at any time. Therefore the problem of reconfiguring a style of a replicated page element caused by separation of the replicated page element (i.e., the target page element) from the document flow of the Web page in existing technologies is thus avoided. The operations are simple with high accuracy, thereby improving the efficiency and the reliability of page element control.

Moreover, by using the technical scheme provided in the present disclosure, as the target page element does not separate from document flow of the Web page all times, an original style of the target page element is still effective without the need of re-configuring a style of a replicated page element, thus reducing a great number of operations for configuring the style and thereby improving the efficiency of the page element control.

Moreover, by using the technical scheme provided by the present disclosure and using a frame of a page element (i.e., an auxiliary page element) to process a translucent layer or an opaque layer, the objective of prominently displaying a page element (i.e., a target page element) without the need of changing an original document flow of a Web page is achieved.

For the sake of convenience and simplicity, one of ordinary skill in the art can clearly understand that the working processes of the above system, apparatus and units can be found in corresponding processes of the foregoing method embodiments, and are not redundantly described herein.

In the embodiments provided by the present disclosure, it should be noted that the disclosed system, apparatus and method can be implemented in other manners. For example, the apparatus described in the above embodiments is merely schematic. For instance, the division of the above units is merely performed according to logic functions, and other manners of division exist in practical implementations, such as a plurality of units or elements may be combined or integrated in another system, certain characteristics may be ignored or not executed. On the other hand, the disclosed or discussed inter-coupling, direct coupling or communication connection may be achieved through some interfaces. The indirect coupling or communication connection between apparatuses or units can be in an electrical, mechanical or other form.

Units that are described as separate components for description may be or may not be physically separated from each other. Components that are disclosed as units may be or may not be physical units, i.e., may be located in a single location or may be distributed among a plurality of network units. The objective of the present disclosure can be achieved by choosing part or all of the units according to practical needs.

In addition, all functional units in the embodiments of the present disclosure may be integrated in a processing unit, may exist as physically separate units, or may have two or more units integrated together into a single unit. The integrated unit may be implemented in form of hardware or a combination of hardware and software functional units.

The integrated unit that is implemented in form of a software functional unit may be stored in a computer readable storage media. The software functional unit stored in a storage media includes instructions that cause a computing device (which may include a personal computer, a server or a network device, etc.) to perform acts of the methods described in the embodiments of the present disclosure. The storage media includes a medium that can store program codes such as a USB disk, a portable hard disk, a Read-Only Memory (ROM), a Random Access Memory (RAM), a magnetic disk or an optical disk, etc.

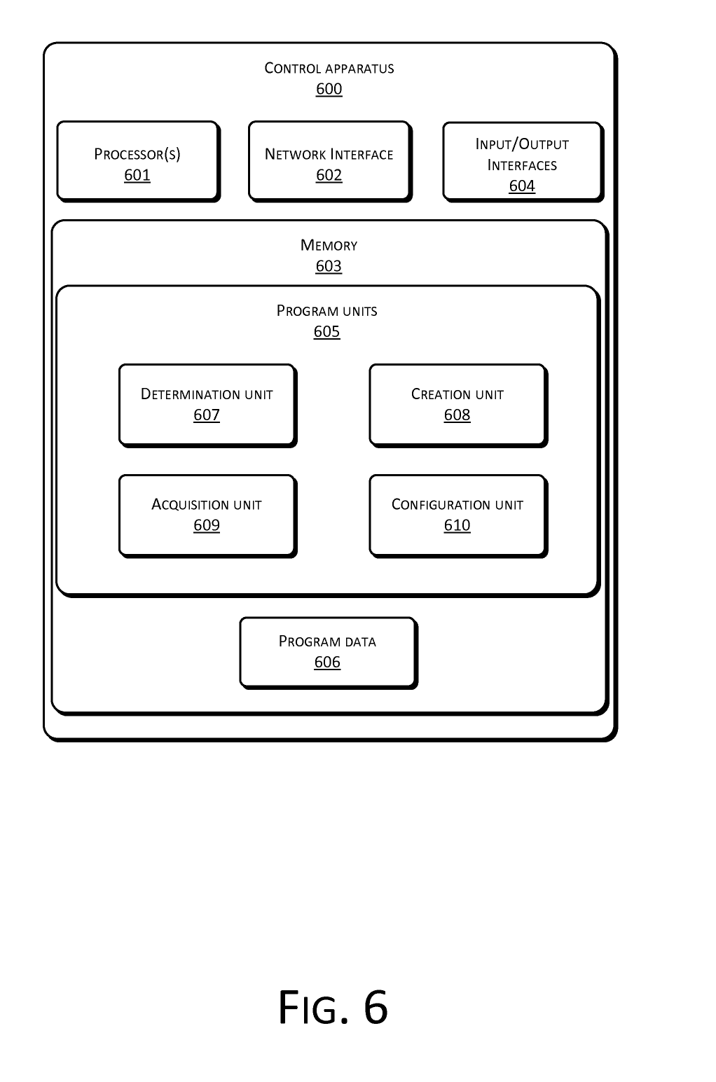

For example, FIG. 6 shows an example control apparatus 600, such as the apparatus as described above, in more detail. In one embodiment, the control apparatus 600 may include, but is not limited to, one or more processors 601, a network interface 602, memory 603 and an input/output interface 604.

The memory 603 may include computer-readable media in the form of volatile memory, such as random-access memory (RAM) and/or non-volatile memory, such as read only memory (ROM) or flash RAM. The memory 603 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 603 may include program units 605 and program data 606. In one embodiment, the program units 605 may include a determination unit 607, a creation unit 608, an acquisition unit 609 and a configuration unit 610. Details about these program units may be found in the foregoing embodiments described above.

Finally, it is noted that the above embodiments are merely used for illustrating the technical schemes of the present disclosure but do not impose any limitations thereon. Although the present disclosure is described in detail by reference to the above embodiments, one of ordinary skill in the art should appreciate that one can modify the technical schemes described in the foregoing embodiments of the present disclosure or equivalently replace some of the technical features therein. These modifications or replacements do not cause the substance of corresponding technical schemes to depart from the spirit and scope of the technical schemes of the embodiments of the present disclosure.

What is claimed is:

1. A method of controlling a page element, comprising:
determining a target page element to be controlled on a World Wide Web (Web) page;
creating an auxiliary page element according to the Web page, a size of the auxiliary page element being a size of the Web page;
obtaining a size of a frame of the auxiliary page element based on the size of the auxiliary page element and a size and a position of the target page element; and
configuring a manner of displaying the frame of the auxiliary page element to be different from a manner of displaying the target page element.

2. The method as recited in claim 1, wherein configuring the manner of displaying the frame of the auxiliary page element to be different from the manner of displaying the target page element comprises:
based on a predetermined transparency parameter, setting a transparency degree for the frame of the auxiliary page element, the transparency parameter being greater than or equal to zero and is less than one.

3. The method as recited in claim 1, wherein obtaining a size of a frame of the auxiliary page element based on the size of the auxiliary page element and a size and a position of the target page element comprises:
obtaining a size difference between the auxiliary page element and the target page element in each direction based on the size of the auxiliary page element and the size and the position of the target page element; and
obtaining the size of the frame of the auxiliary page element based on the size difference in each direction.

4. The method as recited in claim 1, wherein creating an auxiliary page element according to the Web page comprises:
creating the auxiliary page element within a body tag of the Web page.

5. The method as recited in claim 1, wherein prior to obtaining the size of the frame of the auxiliary page element based on the size of the auxiliary page element and the size and the position of the target page element, the method further comprises:
determining the size and the position of the target page element using JavaScript language.

6. The method as recited in claims 1, wherein the auxiliary page element comprises a block element.

7. The method as recited in claim 1, wherein a height of the auxiliary page element is greater than a height of any page element other than the target page element on the Web page.

8. An apparatus of controlling a page element, comprising:
a determination unit used for determining a target page element to be controlled on a Web page of World Wide Web;
a creation unit used for creating an auxiliary page element according to the Web page, a size of the auxiliary page element being a size of the Web page;
an acquisition unit used for obtaining a size of a frame of the auxiliary page element based on the size of the auxiliary page element and a size and a position of the target page element; and
a configuration unit used for configuring a manner of displaying the frame of the auxiliary page element to be different from a manner of displaying the target page element.

9. The apparatus as recited in claim 8, wherein the configuration unit is further used for setting up a transparency degree for the frame of the auxiliary page element based on a preset transparency parameter, the transparency parameter being greater than or equal to zero and is less than one.

10. The apparatus as recited in claim 8, wherein the acquisition unit is further used for:
obtaining a size difference between the auxiliary page element and the target page element in each direction based on the size of the auxiliary page element and the size and the position of the target page element; and
obtaining the size of the frame of the auxiliary page element based on the size difference in each direction.

11. The apparatus as recited in claim 8, wherein the creation unit is further used for creating the auxiliary page element within a body tag of the Web page.

12. The apparatus as recited in claim 8, wherein the determination unit is further used for determining the size and the position of the target page element using JavaScript language.

13. The apparatus as recited in claim 8, wherein the auxiliary page element comprises a block element.

14. The apparatus as recited in claims 8, wherein a height of the auxiliary page element is greater than a height of any page element other than the target page element on the Web page.

15. One or more computer storage media storing executable instructions that, when executed by one or more processors, cause the one or more processors to perform acts comprising:
determining a target page element to be controlled on a Web (World Wide Web) page;
creating an auxiliary page element according to the Web page, a size of the auxiliary page element being a size of the Web page;
obtaining a size of a frame of the auxiliary page element based on the size of the auxiliary page element and a size and a position of the target page element; and
configuring a manner of displaying the frame of the auxiliary page element to be different from a manner of displaying the target page element.

16. The one or more computer storage media as recited in claim 15, wherein configuring the manner of displaying the frame of the auxiliary page element to be different from the manner of displaying the target page element comprises:
based on a predetermined transparency parameter, setting a transparency degree for the frame of the auxiliary page element, the transparency parameter being greater than or equal to zero and is less than one.

17. The one or more computer storage media as recited in claim 15, wherein obtaining a size of a frame of the auxiliary page element based on the size of the auxiliary page element and a size and a position of the target page element comprises:
obtaining a size difference between the auxiliary page element and the target page element in each direction based on the size of the auxiliary page element and the size and the position of the target page element; and
obtaining the size of the frame of the auxiliary page element based on the size difference in each direction.

18. The one or more computer storage media as recited in claim 15, wherein creating an auxiliary page element according to the Web page comprises:
creating the auxiliary page element within a body tag of the Web page.

19. The one or more computer storage media as recited in claim 15, wherein prior to obtaining the size of the frame of the auxiliary page element based on the size of the auxiliary page element and the size and the position of the target page element, the method further comprises:
determining the size and the position of the target page element using JavaScript language.

20. The one or more computer storage media as recited in claim 15, wherein a height of the auxiliary page element is greater than a height of any page element other than the target page element on the Web page.
